(19) United States
(12) Patent Application Publication
(10) Pub. No.: US 2017/0331231 A1
(43) Pub. Date: Nov. 16, 2017

(54) Multifunctional Wall Socket

(71) Applicant: Winon Holding Company Limited, Hong Kong (HK)

(72) Inventor: Kwan Mo NG, Hong Kong (HK)

(21) Appl. No.: 15/525,727

(22) PCT Filed: Oct. 22, 2015
(86) PCT No.: PCT/CN2015/092587

§ 371 Date: May 10, 2017

(30) Foreign Application Priority Data
Nov. 12, 2014 (SG) 10201407492U

(51) Int. Cl. H01R 13/66; H02J 7/00

(52) U.S. Cl. CPC H01R 13/665; H02J 7/0042

(57) ABSTRACT

A multifunctional wall socket related to electrical conduction connecting device is provided. In one embodiment, the socket comprises a socket cover with a conventional power connector, and a USB port arranged on the socket cover. The USB port is connected to the output terminal of an AC-DC conversion module arranged on the socket cover. The AC-DC conversion module comprises a rectifier filter module, a modulation step-down module, a current sampling and protection module, a voltage reference module and a feedback control module. The socket may further include a wirelessly-communicable module for controlling delivery of the AC power at the conventional power connector and/or the DC power at the USB port.

### FIELD OF THE INVENTION

The claimed invention relates to a connection device for electrical conduction, particularly to a multifunctional wall socket supporting multiple power outputs, which includes a DC (Direct Current) power output, and/or wirelessly-controllable on-off switching of the outputs.

### BACKGROUND

Existing sockets, as shown in FIG. 1A, generally include a socket cover 1. The socket cover 1 has conventional power connectors 21′, 22′. The conventional power connectors 21′, 22′ are used for connecting to AC (Alternate Current) line power, wherein the conventional power connector 22′ include two live holes. In comparison with the conventional power connector 22′, the conventional power connector 21′ further includes an earth hole. The socket can be mounted onto a wall. As shown in FIG. 1B, a conventional power connector 21′ is also included in the prior art. This conventional power connector 21′ is different from the conventional power connector 21′ as shown in FIG. 1A only by a certain difference in the shape of the connector, but the principles are the same.

Most existing sockets are solely used to provide AC line power connectors. The functions are relatively limited. There is a need for an improved socket with more functions.

### SUMMARY OF THE INVENTION

A first aspect of the claimed invention is to provide a multifunctional wall socket to supplement the shortcomings in the existing socket technology which has relatively limited functions, as most existing sockets are solely used to provide AC line power connectors.

The multifunctional wall socket implemented by the claimed invention comprises a socket cover, the socket cover including conventional power connectors, the conventional power connectors being used for connecting to AC line power, wherein: a DC output port is further arranged in said socket cover, an AC-DC (Alternate Current-Direct Current) conversion module is arranged in said socket cover, said AC-DC conversion module being connected to the AC line power connector with an output terminal outputting DC and connecting to the DC output port.

Said AC-DC conversion module may comprise a rectifier filter module, a modulation step-down module, a current sampling and protection module, a voltage reference module and a feedback control module, the rectifier filter module and modulation step-down module being connected to each other, the current sampling and protection module and the voltage reference module being connected to the feedback control module, and the output of the feedback control module is connected to the modulation step-down module, wherein:
said rectifier filter module performs rectification and filtering processing on the AC input, generating coarsely-adjusted DC to output to the modulation step-down module;
said modulation step-down module generates a modulation signal through a transformer and a switching chip, outputting a secondary DC voltage to the current sampling and protection module and the voltage reference module after rectification and filtering;
said current sampling and protection module acquires a feedback current, and transmits an over-current signal to the feedback control module, to control feedback current parameters;
said voltage reference module transmits a voltage signal to the feedback control module, outputting a pre-determined DC voltage at the DC output port through the voltage reference module and the feedback control module; and
said feedback control module feeds back current control signal and voltage control signal to the modulation step-down module.

Preferably, the DC port is a USB port, so that the pre-determined DC voltage is in conformity with the electrical parameters of the standard USB/specific port.

Indicator lights may be further arranged on said socket cover, said indicator lights showing the working status of said AC-DC conversion module.

A safety shutter which may be arranged at the location of the conventional power connector in said socket plate.

Said safety shutter may comprise a slide corresponding to the earth hole, and a linear spring biased against the said slide, wherein:
opening is provided in the middle of said slide, said opening corresponding to the earth hole of the conventional power connector;
said slide can cover the live holes of the conventional power connector; and
after an external pin is inserted into the earth hole and the opening, said slide displaces laterally away from the location of the live holes.

The slide may include a main body, wherein:
an oblique opening is provided in the middle of said main body;
one end of said main body is attached with an protruding rod, and the linear spring may be fitted onto the protruding rod;
wings are attached on both sides of the other end of the main body, said two wings being located at the two live holes of the conventional power connector.

The beneficial effects of this invention are: in the claimed invention, a USB port is further arranged in a socket cover, a AC-DC conversion module is arranged in said socket cover, the input terminals of the AC-DC conversion module is connected to the AC line power with its output terminals outputting DC power and connecting with the USB port so that the USB port on the socket cover can be used as the charging port for electrical appliances (with USB plug), increasing the functions of the socket.

In the claimed invention, a wirelessly-communicable module for controlling delivery of electrical power is also provided. Advantageously and preferably, this power-delivery controlling module is incorporable into the multifunctional wall socket for controlling whether or not the AC power is delivered at the conventional power connector and/or whether or not the DC power is delivered at the DC output port.

The power-delivery controlling module comprises one or more on/off switches each of which includes a first terminal and a second terminal. The first terminal is connectable to an electrical power source for receiving electrical power therefrom. An individual switch is controllable, by a controlling signal, to either make or break an electrical path between the first terminal and the second terminal such that the individual switch is reconfigurable to either provide or not provide the electrical power to the second terminal. The module further comprises a wireless transceiver configured to wirelessly communicate with an external router and to receive therefrom a command of controlling the delivery of electrical power. The wireless transceiver may support one or more of the following communication technologies in wirelessly communicating with the router: Wi-Fi; Bluetooth; and any public mobile-communication standard including 2.4G, 3G and 4G etc. Furthermore, a computing processor is included in the module. The computing processor is configured to, upon receiving the command from the router, determine the making or the breaking of the electrical path to be realized in the individual switch for responding to the command, and generate the controlling signal for each of the switches.

Optionally, the module further comprises a power regulator connectable to AC line power. The power regulator converts the AC line power to a DC regulated power for powering the wireless transceiver and the computing processor.

Other aspects of the present invention are disclosed as illustrated by the embodiments hereinafter.

### BRIEF DESCRIPTION OF THE DRAWINGS

FIG. 1A is a schematic drawing for the design of a socket in the existing technology.

FIG. 1B is a schematic drawing for the design of another socket in the existing technology.

FIG. 2 is a schematic drawing for the claimed invention.

FIG. 3 is a drawing of a circuit connection principle of the claimed invention.

FIG. 4 is a schematic drawing for an AC-DC conversion module of the claimed invention.

FIG. 5 is a schematic drawing for a circuit connection of the indicator lights.

FIG. 6 is a schematic drawing for the design of another connector application of the claimed invention.

FIG. 7 is a schematic drawing of a wirelessly-communicable module for controlling delivery of electrical power.

FIG. 8 depicts one example illustrating the convenience of controlling appliances at home by a smart phone with the use of multifunctional wall sockets each having a built-in power-delivery controlling module.

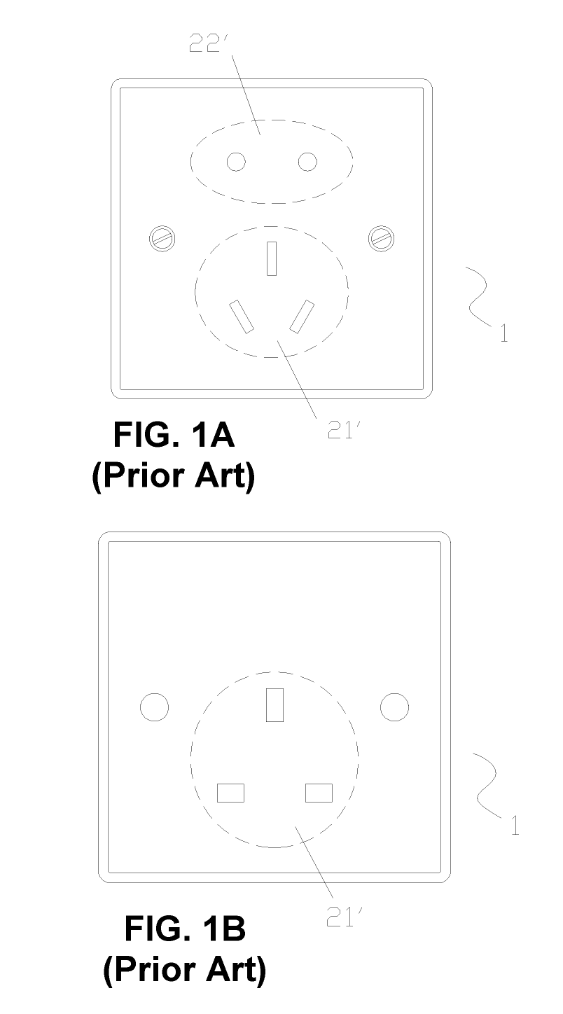

### DETAILED DESCRIPTION

The following further describes the claimed invention in detail according to the figures and embodiments.

A first aspect of the present invention is to provide a multifunctional wall socket for mounting in a wall or in a standard mount box, and configured to wire to conventional AC line power, the wall socket having a socket cover, the socket cover having a conventional power connector, said conventional power connector being connectable to AC line power. In particular, said socket cover is further arranged with a DC output port and an AC-DC conversion module, where an input terminal of the AC-DC conversion module is connectable to the AC line power, and an output terminal thereof is connectable to the DC output port for outputting a pre-determined DC voltage thereto.

Preferably, the DC output port is a USB port, and the pre-determined DC voltage is a voltage in conformity with the electrical parameters of a standard USB port. In the description hereinafter, the USB port is used as an example of the DC output port for describing the invention.

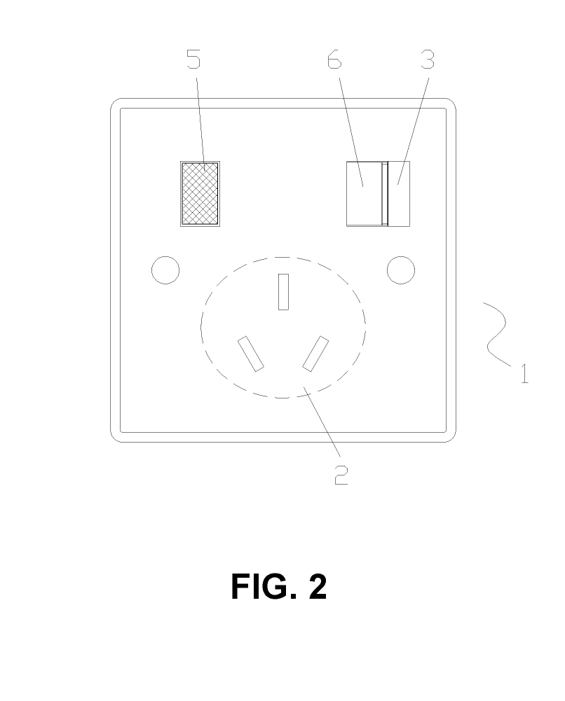

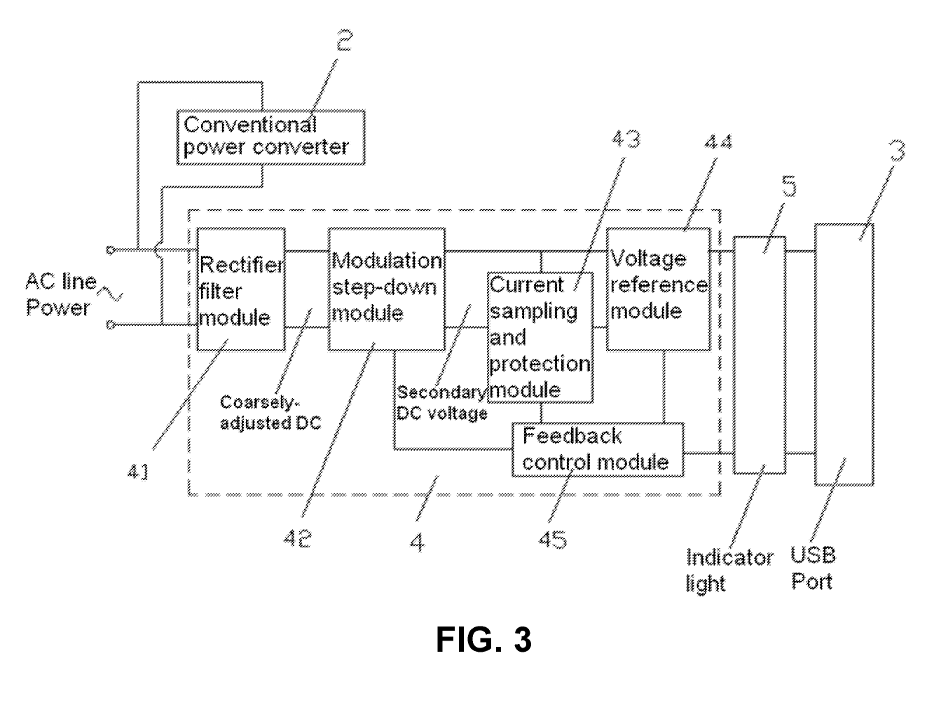

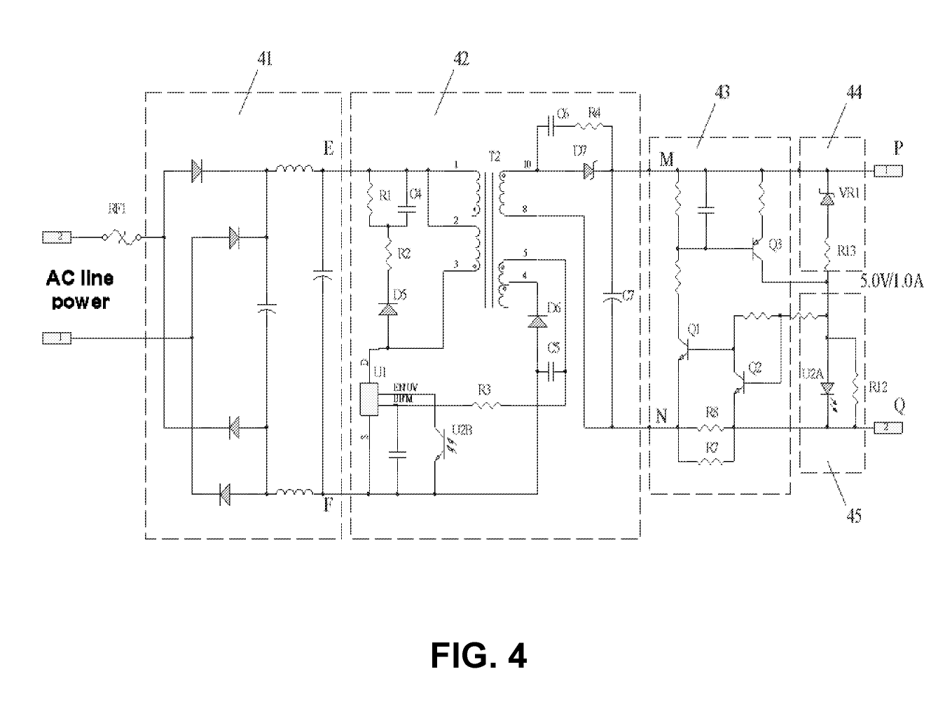

According to FIG. 2, FIG. 3 and FIG. 4, the claimed invention comprises a socket cover 1. As shown in FIG. 2, a conventional power connector 2 and a USB port 3 are arranged on the socket cover 1. The conventional power connector 2 is used to connect to the AC line power. an AC-DC conversion module is arranged in the socket cover 1. The input terminal of the AC-DC conversion module connects to the AC line power. The output terminals of the AC-DC conversion module connect with the USB port 3. Optionally, the output terminals of the AC-DC conversion module may also connect with a connection indicator light 5 in between. As shown in FIG. 3, the conventional power connector 2 directly connects to the AC line power, an AC-DC conversion module 4 including a safety module RF1 (not shown), a rectifier filter module 41, a modulation step-down module 42, a current sampling and protection module 43, a voltage reference module 44 and a feedback control module 45. The safety module RF1, the voltage reference module 44 and the feedback control module 45 are connected together. The current sampling and protection module 43 and the voltage reference module 44 and the feedback control module 45 are connected. The output of the feedback control module 45 connects to the modulation step-down module 42.

As shown in FIG. 3 and FIG. 4, the rectifier filter module 41 performs rectification and filter processing on the AC input, generating a coarsely-adjusted DC output to the modulation step-down module 42. As shown in FIG. 4, the AC line power is input to the rectifier filter module 41 which outputs a coarsely-adjusted DC at terminal nodes E, F to the modulation step-down module 42 through a diode bridge rectifier, then through a LC filter.

As shown in FIG. 3 and FIG. 4, the modulation step-down module 42 generates the modulated signal through a transformer T2 and a pulse width modulation chip U1, output a secondary DC voltage to a current sampling and protection module 43 and voltage reference module 44 after rectification and filtering.

As shown in FIG. 4, the modulation step-down module 42 comprises a converter circuit, a freewheeling sub-module, a control sub-module and a secondary rectifier filter sub-module.

As shown in FIG. 4, the converter circuit comprises high frequency transformer T2 and its primary coils 2-3, and switching chip U1. The converter circuit converts the DC into a modulated AC, that is: DC current is applied from the positive terminal to the drain terminal D of the switching chip U1 (using TNY274P) through the primary coils 2-3 of the high frequency transformer T2. The DC current flows through the switch transistors in the U1, flowing out of the source terminal S of the switching chip U1 to the negative of the power source. The switch transistors in the switching chip U1 perform ON/OFF operations at a certain frequency. As a result, the primary coils 2-3 of the transformer T2 generate a pulse current which switches on and off, generating an alternating voltage with a certain amplitude in other coils of the transformer T2 through the electromagnetic induction of the transformer T2.

As shown in FIG. 4, the freewheeling sub-module comprises a freewheeling diode D5, a current limiting resistor R2, and a resistor R1 connected in parallel with a capacitor C4. When the switch transistor in the switching ship U1 is OFF, a back EMF (Electromotive Force) is generated in the primary coils of the transformer T2. The back EMF through the freewheeling diode D5 and the current limiting resistor R2 forms a current loop together with a waveform adjustment circuit formed by a resistor R1 and a capacitor C4, providing a channel for release of electrical energy for the back EMF in the primary coils and providing electrical energy for the negative half cycle of a secondary coil.

As shown in FIG. 4, the control sub-module comprises a diode D6, a capacitor C5 and a resistor R3. The diode D6 and the resistor R3 are connected with the two terminals of the secondary coils 4, 5 of the transformer T2. The capacitor C5 is connected between the output terminals of the secondary coils 4, 5. The resistor R3 is connected with the BP/M terminals of the switching chip U1 (TNY274P).

The diode D6, the capacitor C5 and the resistor R3 provides a DC operation power supply to the switching chip U1. The size of the output voltage is controlled by an adjustment/differential signal coupled from optocoupler U2A, U2B (using PC817A). The ON/OFF duty cycle of the switch transistors in the switching chip U1 fulfills the functions of adjusting the voltage size and stabilizing voltage under the pulse width modulation mode (with constant switching frequency).

As shown in FIG. 4, a second rectifier filter sub-module comprises a half-wave rectifier circuit formed by a diode D7 and a capacitor C6, and a filter capacitor C7. The half-wave rectifier circuit is connected at the loop of the coils 8, 10 of the transformer T2. The filter capacitor C7 is connected in parallel with the two terminals of the secondary coils 8, 10, outputting a secondary DC voltage at terminal nodes M, N.

As shown in FIG. 3, the current sampling and protection module 43 obtains the loop current, and transmits the over-current signal to the feedback control module 45 to control the loop current parameters. The voltage reference module 44 transmits the voltage signal to the feedback control module 45. A DC voltage which is in conformity with the electrical parameters of the standard USB port 3 is output through the voltage reference module 44 and the feedback control module 45. The feedback control module 45 feeds back the current control signal and the voltage control signal to the modulation step-down module 42.

As shown in FIG. 4, the current sampling and protection module 43 comprises a sampling sub-module and a signal amplifier sub-module. The sampling sub-module includes a resistor R7 and a resistor R8. The signal amplifier sub-module is formed by connecting three transistors Q1, Q2, Q3 together. When there is over current, the voltage drop across resistors R7, R8 increase, Q2 cut off, Q1 and Q3 conduct. Excess current is transmitted to the feedback control module 45. The current control signal is fed back to the modulation step-down module 42 through the feedback control module 45, reducing the power voltage in order to obtain protection.

As shown in FIG. 4, when the voltage in the circuit increases, the voltage of the voltage reference module 44 remains unchanged and the current through the optocoupler U2A increases. Similarly, when there is over current, the current of the optocoupler U2A increases. The coupling signal through the optocoupler U2A is transmitted to the EN/UV terminals of the switching chip U1 to control the duty cycle of the pulse width modulation so that the voltage in the circuit is reduced to achieve the feedback control for stabilizing current, stabilizing voltage.

As shown in FIG. 2 and FIG. 3, an indicator light 5 may be arranged on the socket cover 1. The indicator light 5 shows the working status of the AC-DC conversion module 4.

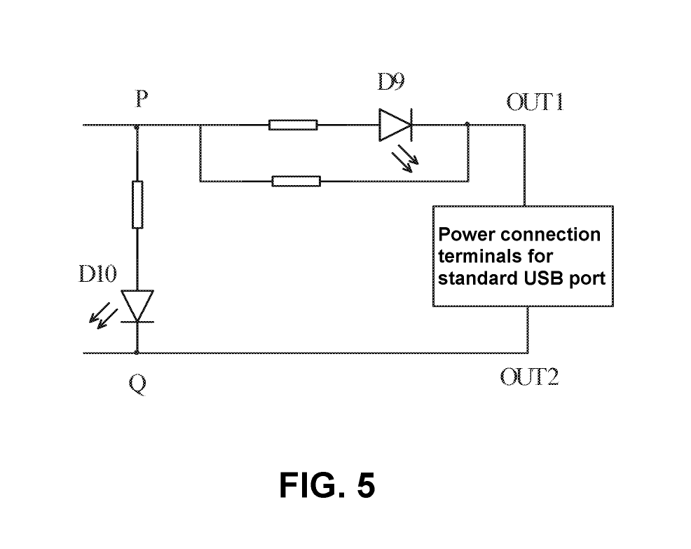

As shown in FIG. 5, the indicator light 5 includes light emitting diodes D9, D10. The light emitting diode D9 can emit red light, and is connected in parallel between the output terminals P, Q of the AC-DC conversion module 4. The light emitting diode D10 can emit green light and is connected in series to the output loop of the AC-DC conversion module 4 and the standard USB port 3. In this way, the output terminals OUT1, OUT2 and the power connection terminals of the standard USB port 3 are directly connected.

When the AC-DC conversion module conducts with the AC line power, the light emitting diode D9 stays on, indicating the power output is normal.

When an electrical appliance is plugged into the USB port 3 to start charging, the light emitting diode D10 is switched on. The light emitting diode D10 gradually dims as the charging current becomes gradually less, and is switched off when the electrical appliance is fully charged.

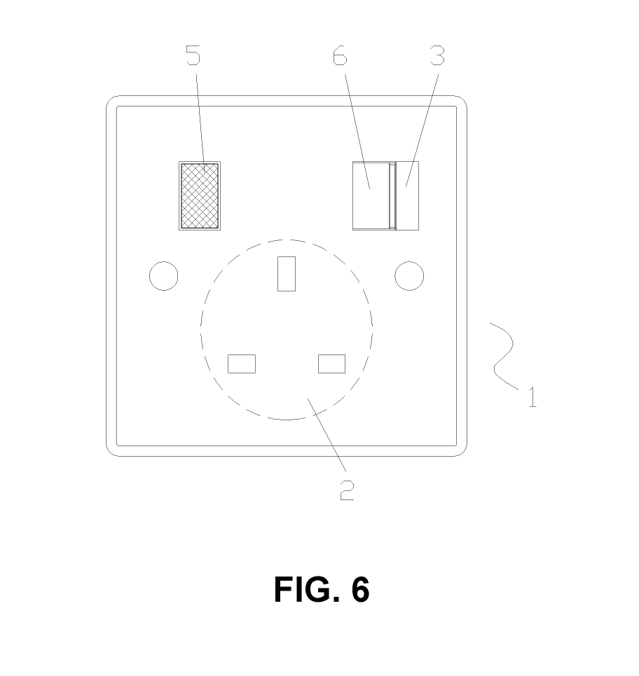

When compared with FIG. 2, the differences in the drawing for a design of another type of connector as shown in FIG. 6 are just certain differences in the shape of the connectors. It is similar to the aforesaid embodiments in term of basic structures, principles, methods which will not be redundantly repeated here.

A second aspect of the present invention is a wirelessly-communicable module for controlling delivery of electrical power. In particular, the module is controllable by an external computing device through commands sent to the module via a wireless communication channel between the external device and the module. Preferably, this power-delivery controlling module is incorporated into the multifunctional wall socket disclosed above for controlling whether or not the AC power is delivered at the conventional power connector 2 and/or whether or not the DC power is delivered at the DC output port (e.g., the USB port 3). Thereby, on-off switching of one or more power outputs for the socket is provided. When the multifunctional wall socket includes such module, one practical advantage is that an end user of the wall socket is capable of using a mobile computing device, such as a smart phone, to instruct the wall socket to provide or to stop providing the AC or DC power to an electrical appliance that is connected to the wall socket.

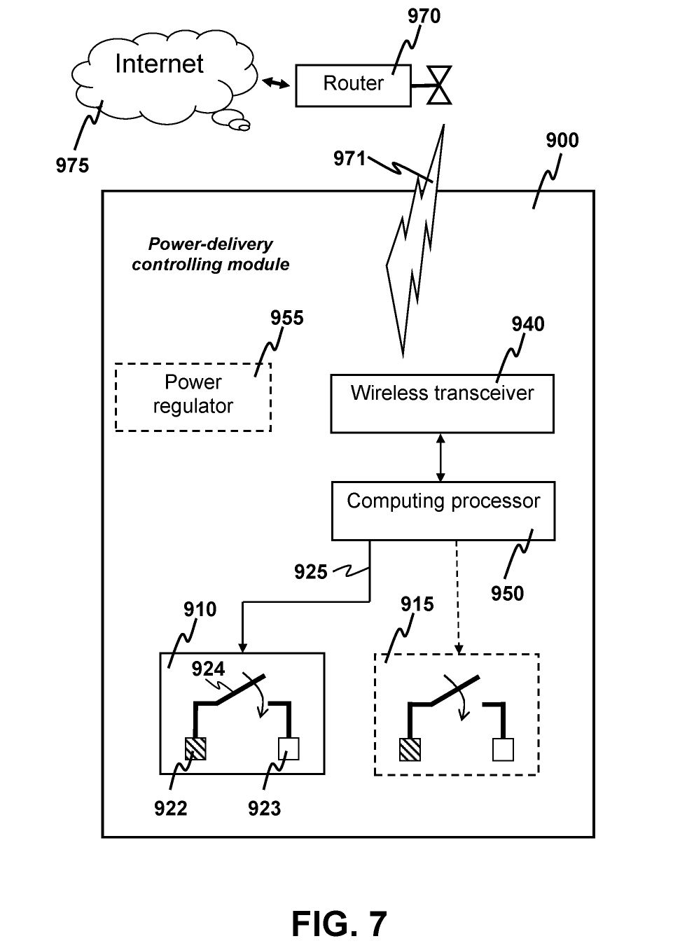

Exemplarily, the module is illustrated as follows with the aid of FIG. 7, which depicts a schematic diagram of the module. A wirelessly-communicable power-delivery controlling module 900 comprises one or more on/off switches (as illustrated as one switch 910 and an optional switch 915). Take the switch 910 as a reference for illustration. The switch 910 includes a first terminal 922 and a second terminal 923. The first terminal 922 is connectable to an electrical power source for receiving electrical power therefrom. The switch 910 is controllable, by a controlling signal 925, to either make or break an electrical path 924 between the first terminal 922 and the second terminal 923. As a result, the switch 910 is reconfigurable to either provide or not provide the electrical power to the second terminal 923. The module 900 further comprises a wireless transceiver 940 configured to wirelessly communicate with an external router 970 through a wireless communication channel 971 and to receive from the router 970 a command of controlling the delivery of electrical power. Note that the external router 970 is not part of the module 900. The router 970 is any electronic computing device configured to wirelessly communicate with the wireless transceiver 940. In addition, the module 900 additionally comprises a computing processor 950 configured to, when the command from the router 970 is received, determine the making or the breaking of the electrical path 924 to be realized in the switch 910 for responding to the command, and generate the controlling signal 925. The controlling signal 925 is received by the switch 910, thereby executing the command that is received.

In some implementations of the module 900, the switch 910 is realizable as a mechanical relay or a solid-state switch.

Depending on practical realization of the module 900, the first terminal 922 and the second terminal 923 may be made to be substantially similar in physical form so that the two terminals 922, 923 are interchangeable. This swapping is possible if, for example, the switch 910 is a mechanical relay having a pair of symmetrical terminals. Alternatively, in some implementations such as some types of unidirectional solid-state switches, the first terminal 922 is configured only for receiving electrical power while the second terminal 923 is strictly configured for providing the power.

The wireless transceiver 940 is used for communicating with the router 970. Examples of communication technologies that the wireless transceiver 940 may support for making communication with the router 970 include Wi-Fi, Bluetooth, and any public mobile-communication standard such as 2.4G, 3G and 4G. In a majority of application scenarios, the router 970 is connected to the Internet 975 so that the router is Internet-enabled. Correspondingly, the wireless transceiver 940 is further configured for communicating with the router 970 that is Internet-enabled.

Optionally, a power regulator 955 connectable to AC line power is included in the module 900 for converting the AC line power to a DC regulated power for powering the wireless transceiver 940 and the computing processor 950. The power regulator 955 is an optional feature in that when the module 900 is used in the multifunctional wall socket as disclosed above, the socket provides DC power (see FIG. 4 and the corresponding description above).

The power-delivery controlling module 900 is incorporable into any embodiment of the multifunctional wall socket disclosed above. In a first configuration, the switch 910 has the first terminal 922 connected to the AC line power and the second terminal 923 connected to the conventional power connector of the socket. In a second configuration, the switch 910 has the first terminal 922 connected to the output terminal of the AC-DC conversion module and the second terminal connected to the DC output port. In a third configuration, which is substantially a combination of the first and the second configurations, the switch 910 and the other one 915 are used for controlling the AC power output and the DC power output, respectively.

As an example of illustrating a practical advantage of using the disclosed module 900, an end user of the multifunctional wall socket having the power-delivery controlling module 900 built-in can conveniently control delivering of the AC or DC power to an electrical appliance that is connected to the socket by simply issuing a command through the end user's Internet-enabled smart phone, or by a personal computer, or even by a public computer.

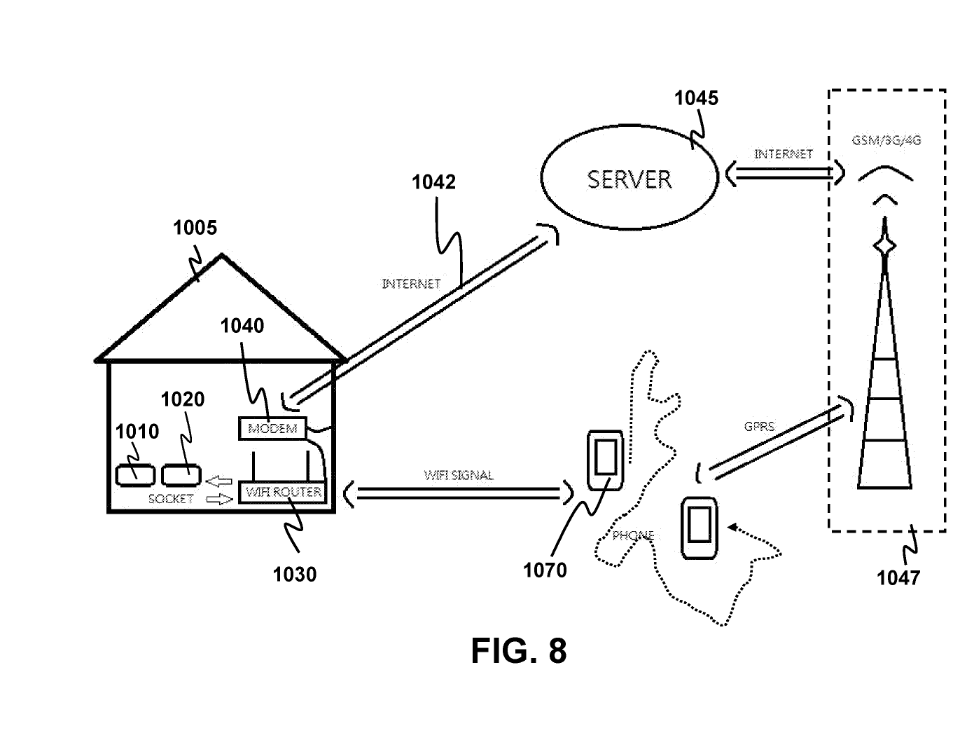

FIG. 8 shows one example for illustrating the convenience of controlling appliances at home by a smart phone/portable device/computer with the use of disclosed multifunctional wall sockets having built-in power-delivery controlling modules. A home 1005 has multifunctional wall sockets 1010, 1020 installed, each wirelessly communicable with a WiFi router 1030, which in turns is connected to a home-based modem 1040. The modem 1040 is connected to a server 1045 that serves this modem 1040 via the Internet 1042. A home user, when nearby the home 1005, can use a WiFi-enabled smart phone 1070 to send a command directly to the router 1030 for switching on or off an AC output of one of the sockets, say the socket 1010. Upon receipt of the command from the smart phone/portable device/computer 1070, the router 1030 relays the command to the socket 1010 for execution. When the home user is away from the home 1005, the smart phone/portable device/computer 1070 is no longer able to directly communicate with the router 1030. Instead, the command can be sent from the smart phone/portable device/computer 1070 to a mobile communication system 1047, which can be a GSM, a 3G or a 4G system. The mobile communication system 1047 then relays the command through the server 1045 to the modem 1040, from which the router 1030 can obtain the command. The command is then forwarded from the router 1030 to the socket 1010 for execution so as to switch on or off the AC output thereof accordingly.

The computing processor as mentioned herein may be implemented as one or more general purpose processors or one or more specialized computing devices, a computer processor, a microcontroller, or an electronic circuitry including but not limited to a digital signal processor (DSP), an application specific integrated circuits (ASIC), a field programmable gate array (FPGA), and any other programmable logic device configured or programmed according to the teachings of the present disclosure. Computer instructions or software codes running in the general purpose or specialized computing devices, computer processors, microcontrollers, or programmable logic devices can readily be prepared by practitioners skilled in the software or electronic art based on the teachings of the present disclosure.

In conclusion, the basic structures, principles and control methods of the invention are specifically described through the above embodiments. Under the hypothesis of not deviating from the main ideas of the claimed invention, the person skilled in the art can implement various variations/alternate forms or combinations without carrying out any inventive work.

1. A multifunctional wall socket for mounting in a wall or in a standard mount box, and configured to wire to conventional AC line power, the wall socket having a socket cover, the socket cover having a conventional power connector, said conventional power connector being connectable to AC line power, wherein:
a DC output port is further arranged in said socket cover; and
an AC-DC conversion module is further arranged in said socket cover, an input terminal of the AC-DC conversion module being connected to the AC line power, an output terminal thereof being connectable to the DC output port for outputting DC.

2. The multifunctional wall socket according to claim 1, wherein:
said AC-DC conversion module includes a rectifier filter module, a modulation step-down module, a current sampling and protection module, a voltage reference module and a feedback control module, where the rectifier filter module and the modulation step-down module are connected, the current sampling and protection module and the voltage reference module are connected to the feedback control module, and the output of the feedback control module is connected to the modulation step-down module;
said rectifier filter module performs rectification and filter processing on the AC input, generating a coarsely-adjusted DC to output to the modulation step-down module;
said modulation step-down module generates a modulation signal through a transformer and a switching chip, outputting a secondary DC voltage to the current sampling and protection module and the voltage reference module after rectification and filtering;
said current sampling and protection module acquires a feedback current, and transmits an over-current signal to the feedback control module, to control the parameters of the feedback current;
said voltage reference module transmits a voltage signal to the feedback control module, outputting a pre-determined DC voltage at the DC output port; and
said feedback control module feeds back current control signal and voltage control signal to the modulation step-down module.

3. The multifunctional wall socket according to claim 2, wherein:
the DC output port is a USB port; and
the pre-determined DC voltage is a voltage in conformity with the electrical parameters of a standard USB port.

4. The multifunctional wall socket according to claim 1 or 2, wherein:
a safety shutter which can be opened or closed is arranged at the conventional power connector in said socket cover.

5. A wirelessly-communicable module for controlling delivery of electrical power, comprising:
one or more on/off switches each of which includes a first terminal and a second terminal, the first terminal being connectable to an electrical power source for receiving electrical power therefrom, an individual switch being controllable, by a controlling signal, to either make or break an electrical path between the first terminal and the second terminal such that the individual switch is reconfigurable to either provide or not provide the electrical power to the second terminal;
a wireless transceiver configured to wirelessly communicate with an external router and to receive therefrom a command of controlling the delivery of electrical power; and
a computing processor configured to, upon receiving the command from the router, determine the making or the breaking of the electrical path to be realized in the individual switch for responding to the command, and generate the controlling signal for each of the switches.

6. The module of claim 5, wherein the wireless transceiver supports one or more of the following communication technologies in wirelessly communicating with the router: Wi-Fi; Bluetooth; and any public mobile-communication standard including 2.4G, 3G and 4G etc.

7. The module of claim 5, wherein the wireless transceiver is further configured for communicating with the router that is Internet-enabled.

8. The module of claim 5, wherein the individual switch is a solid-state switch.

9. The module of claim 5, further comprising:
a power regulator connectable to AC line power, for converting the AC line power to a DC regulated power for powering the wireless transceiver and the computing processor.

10. A multifunctional wall socket for mounting in a wall or in standard mount box, and configured to wire to conventional AC line power, the wall socket having a socket cover, the socket cover having a conventional power connector, said conventional power connector being connectable to AC line power, wherein:
a DC output port is further arranged in said socket cover;
an AC-DC conversion module is further arranged in said socket cover, an input terminal of the AC-DC conversion module being connected to the AC line power, an output terminal thereof being connectable to the DC output port for outputting DC; and
the wirelessly-communicable power-delivery controlling module of claim 5 is further arranged in the socket, wherein the power-delivery controlling module is further arranged to have one of the following configurations:
(a) one of the switches has the first terminal connected to the AC line power and the second terminal connected to the conventional power connector;
(b) one of the switches has the first terminal connected to the output terminal of the AC-DC conversion module and the second terminal connected to the DC output port; and
(c) a first one of the switches has the first terminal connected to the AC line power and the second terminal connected to the conventional power connector, and a second one of the switches has the first terminal connected to the output terminal of the AC-DC conversion module and the second terminal connected to the DC output port.

11. The multifunctional wall socket according to claim 10, wherein:
said AC-DC conversion module includes a rectifier filter module, a modulation step-down module, a current sampling and protection module, a voltage reference module and a feedback control module, where the rectifier filter module and the modulation step-down module are connected, the current sampling and protection module and the voltage reference module are connected to the feedback control module, and the output of the feedback control module is connected to the modulation step-down module;
said rectifier filter module performs rectification and filter processing on the AC input, generating a coarsely-adjusted DC to output to the modulation step-down module;
said modulation step-down module generates a modulation signal through a transformer and a switching chip, outputting a secondary DC voltage to the current sampling and protection module and the voltage reference module after rectification and filtering;
said current sampling and protection module acquires a feedback current, and transmits an over-current signal to the feedback control module, to control the parameters of the feedback current;
said voltage reference module transmits a voltage signal to the feedback control module, outputting a pre-determined DC voltage at the DC output port; and
said feedback control module feeds back current control signal and voltage control signal to the modulation step-down module.

12. The multifunctional wall socket according to claim 10, wherein:
the DC output port is a USB port; and
the pre-determined DC voltage is a voltage in conformity with the electrical parameters of a standard USB port.

13. The multifunctional wall socket according to claim 10, wherein:
a safety shutter which can be opened or closed is arranged at the conventional power connector in said socket cover.

14. A multifunctional wall socket for mounting in a wall or in standard mount box, and configured to wire to conventional AC line power, the wall socket having a socket cover, the socket cover having a conventional power connector, said conventional power connector being connectable to AC line power, wherein:
a DC output port is further arranged in said socket cover;
an AC-DC conversion module is further arranged in said socket cover, an input terminal of the AC-DC conversion module being connected to the AC line power, an output terminal thereof being connectable to the DC output port for outputting DC; and
the wirelessly-communicable power-delivery controlling module of claim 9 is further arranged in the socket, wherein the power-delivery controlling module is further arranged to have one of the following configurations:
(a) one of the switches has the first terminal connected to the AC line power and the second terminal connected to the conventional power connector;
(b) one of the switches has the first terminal connected to the output terminal of the AC-DC conversion module and the second terminal connected to the DC output port; and
(c) a first one of the switches has the first terminal connected to the AC line power and the second terminal connected to the conventional power connector, and a second one of the switches has the first terminal connected to the output terminal of the AC-DC conversion module and the second terminal connected to the DC output port.

15. The multifunctional wall socket according to claim 14, wherein:
said AC-DC conversion module includes a rectifier filter module, a modulation step-down module, a current sampling and protection module, a voltage reference module and a feedback control module, where the rectifier filter module and the modulation step-down module are connected, the current sampling and protection module and the voltage reference module are connected to the feedback control module, and the output of the feedback control module is connected to the modulation step-down module;
said rectifier filter module performs rectification and filter processing on the AC input, generating a coarsely-adjusted DC to output to the modulation step-down module;
said modulation step-down module generates a modulation signal through a transformer and a switching chip, outputting a secondary DC voltage to the current sampling and protection module and the voltage reference module after rectification and filtering;
said current sampling and protection module acquires a feedback current, and transmits an over-current signal to the feedback control module, to control the parameters of the feedback current;
said voltage reference module transmits a voltage signal to the feedback control module, outputting a pre-determined DC voltage at the DC output port; and
said feedback control module feeds back current control signal and voltage control signal to the modulation step-down module.

16. The multifunctional wall socket according to claim 14, wherein:
the DC output port is a USB port; and
the pre-determined DC voltage is a voltage in conformity with the electrical parameters of a standard USB port.

17. The multifunctional wall socket according to claim 14, wherein:
a safety shutter which can be opened or closed is arranged at the conventional power connector in said socket cover.
